(19) United States
(12) Patent Application Publication
(10) Pub. No.: US 2011/0232089 A1
(43) Pub. Date: Sep. 29, 2011

(54) Method of manufacturing inkjet print head

(75) Inventors: Suk Ho Song, Ansan (KR); Chung Mo Yang, Ansan (KR); Jae Woo Joung, Suwon (KR)

(73) Assignee: SAMSUNG ELECTRO-MECHANICS CO., LTD., Suwon (KR)

(21) Appl. No.: 12/805,020

(22) Filed: Jul. 7, 2010

(30) Foreign Application Priority Data
Mar. 25, 2010 (KR) 10-2010-0026805

(51) Int. Cl. B23P 17/00

(52) U.S. Cl. 29/890.1

(57) ABSTRACT

There is provided a method of manufacturing an inkjet print head. The method includes providing a head portion having a dummy portion disposed on a surface of a pressure area pressurizing an ink chamber, a nozzle connected to the ink chamber for ink ejection and the ink chamber for ink supply to the nozzle, and removing the dummy portion. The method allows for the improvement of ink ejection and nozzle density. Also, the method allows for the forming of a thin-type head portion using the dummy portion.

### CROSS-REFERENCE TO RELATED APPLICATIONS

This application claims the priority of Korean Patent Application No. 10-2010-0026805 filed on Mar. 25, 2010, in the Korean Intellectual Property Office, the disclosure of which is incorporated herein by reference.

### BACKGROUND OF THE INVENTION

1. Field of the Invention

The present invention relates to a method of manufacturing an inkjet print head, and more particularly, to a method of manufacturing an inkjet print head allowing for the improvement of ink ejection and nozzle density.

2. Description of the Related Art

In general, an inkjet print head converts electrical signals into physical impulses so that ink droplets are ejected through a small nozzle.

In recent years, an inkjet print head has been widely used in industrial inkjet printers. For example, it is used to directly form a circuit pattern by spraying ink prepared by melting a metal such as gold or silver onto a printed circuit board (PCB). It is also used for creating industrial graphics, or for the manufacturing of a liquid crystal display (LCD), an organic light emitting diode (OLED) and a solar cell.

The applications of industrial inkjet print technology have been continuously expanded. In this regard, a variety of studies regarding variations in ink droplet size and ink types, high-speed ejection, high-density nozzles, and the like are being carried out.

In order to satisfy various demands with relation to the industrial inkjet print technology, a piezoelectric inkjet print head is currently being widely used. The piezoelectric inkjet print head, using a piezoelectric material and a membrane having a thickness of tens of μm, causes the generation of ink droplet by pushing the ink within an ink pressure area to a nozzle.

Such a piezoelectric inkjet print head is manufactured by bonding silicon wafers, in which the silicon wafers have various elements, such as a membrane, a chamber and a nozzle, formed therein by a Micro-Electro-Mechanical Systems (MEMS) technology (light exposure, development, and bonding process).

The MEMS should allow for variations in the size of an ink pressure area according to droplet volume, ejection velocity, nozzle density, and the like. Here, the process technology of a membrane and a piezoelectric material, and the thickness thereof should be freely varied according to the variations in the size of the ink pressure area.

### SUMMARY OF THE INVENTION

An aspect of the present invention provides a method of manufacturing an inkjet print head allowing for the improvement of ink ejection and nozzle density.

According to an aspect of the present invention, there is provided a method of manufacturing an inkjet print head, the method comprising: providing a head portion including a dummy portion disposed on a surface of an area pressurizing an ink chamber, a nozzle connected to the ink chamber for ink ejection, and the ink chamber for ink supply to the nozzle; and removing the dummy portion.

The providing of the head portion may include forming the dummy portion to be integrated with the head portion as a single body.

The providing of the head portion may include forming the dummy portion to be attached to the head portion.

The removing of the dummy portion may be performed by using at least one method selected from the group consisting of a chemical polishing method, a mechanical polishing method, a chemical mechanical polishing method, and a reactive ion etching method.

The providing of the head portion may include forming the ink chamber and the nozzle in a single body.

The providing of the head portion may include forming a nozzle plate having the nozzle formed therein and forming a chamber plate having the ink chamber formed therein.

The providing of the head portion may include forming an intermediate plate interposed between the chamber plate and the nozzle plate and having a damper formed therein, the damper connecting the ink chamber and the nozzle.

The removing of the dummy portion may be performed such that the chamber plate may have a thickness of 10 μm to 50 μm.

### BRIEF DESCRIPTION OF THE DRAWINGS

The above and other aspects, features and other advantages of the present invention will be more clearly understood from the following detailed description taken in conjunction with the accompanying drawings, in which:

FIGS. 1A through 1F are schematic cross-sectional views illustrating a method of manufacturing a chamber plate of an inkjet print head according to an exemplary embodiment of the present invention;

FIGS. 2A through 2G are schematic cross-sectional views illustrating a method of manufacturing an intermediate plate of an inkjet print head according to an exemplary embodiment of the present invention;

FIGS. 3A through 3H are schematic cross-sectional views illustrating a method of manufacturing a nozzle plate of an inkjet print head according to an exemplary embodiment of the present invention;

FIGS. 4A through 4E are schematic cross-sectional views illustrating a method of bonding a chamber plate, an intermediate plate and a nozzle plate of an inkjet print head according to an exemplary embodiment of the present invention;

FIG. 5 is a schematic cross-sectional view illustrating an ink chamber of an inkjet print head according to an exemplary embodiment of the present invention;

FIG. 6 is a partial perspective view schematically illustrating a method of manufacturing an inkjet print head according to another exemplary embodiment of the present invention;

FIG. 7 is a cross-sectional view illustrating the inkjet print head of FIG. 6;

FIG. 8 is a graph illustrating the internal pressure variation of an ink chamber according to the thickness of a pressure area in an inkjet print head according to an exemplary embodiment of the present invention; and

FIG. 9 is a graph illustrating the thickness range of a pressure area having a maximum displacement width according to the thickness of an actuator in an inkjet print head according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions may be exaggerated for clarity, and the same reference numerals will be used throughout to designate the same or like elements.

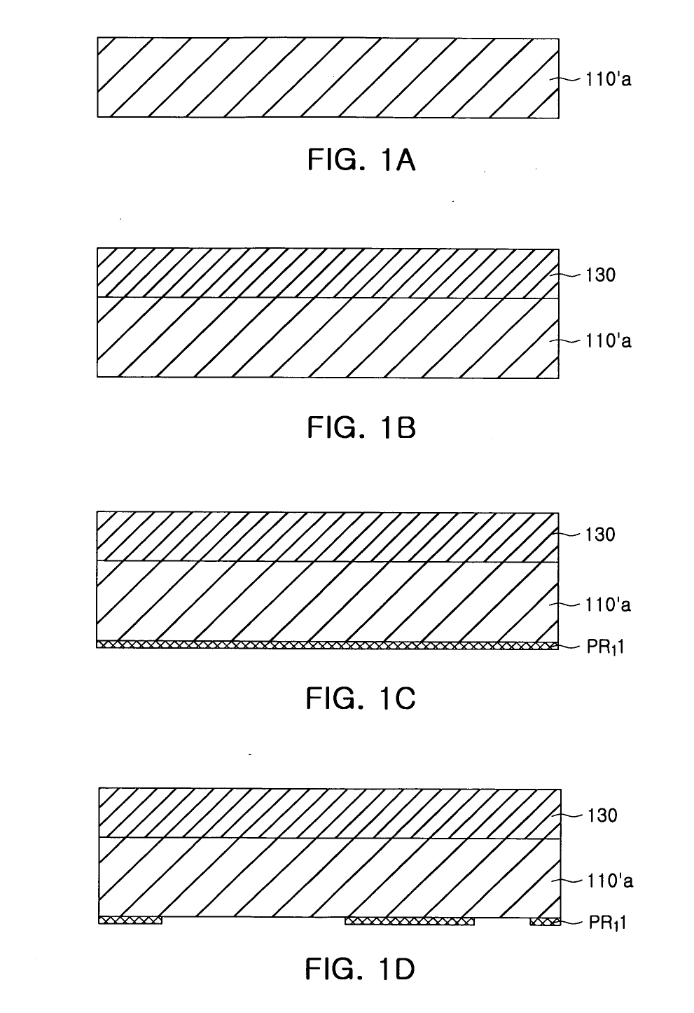

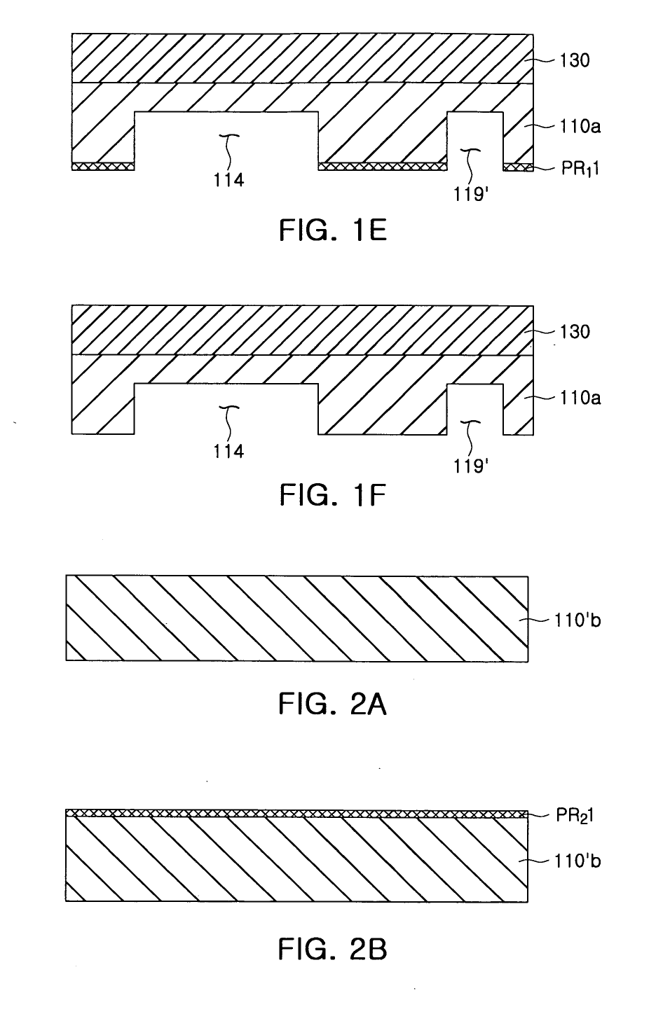

Hereinafter, a method of manufacturing an inkjet print head according to an exemplary embodiment of the present invention will be described with reference to FIGS. 1A through 4E.

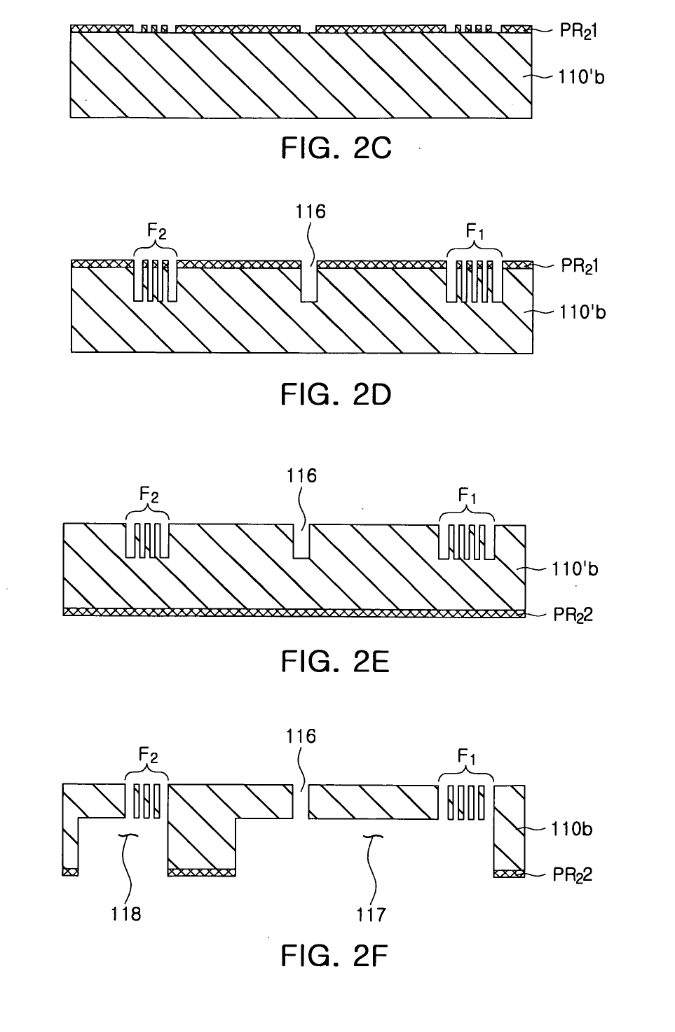

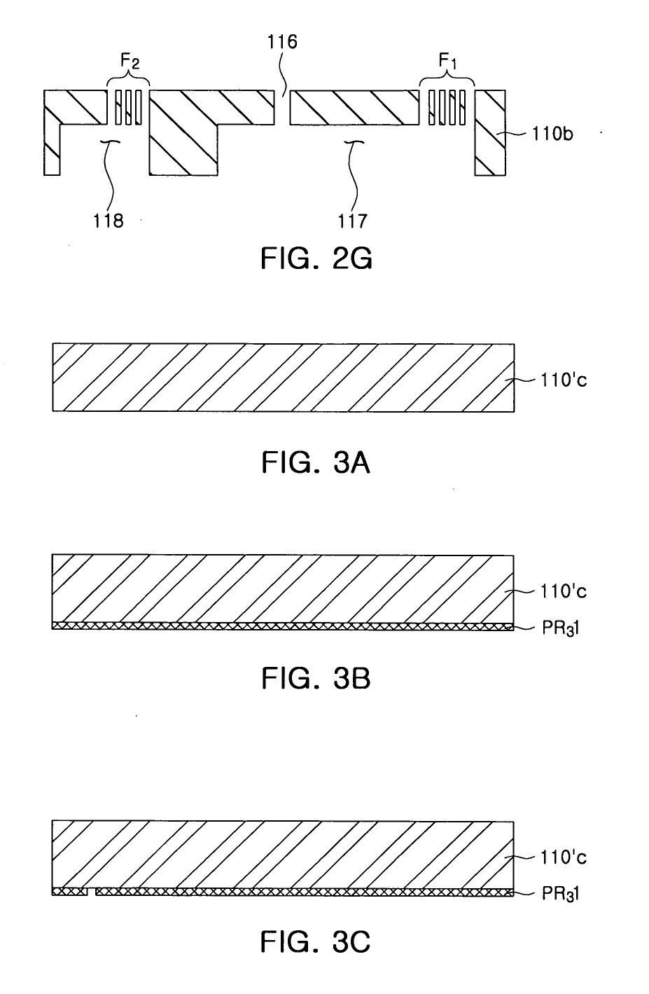

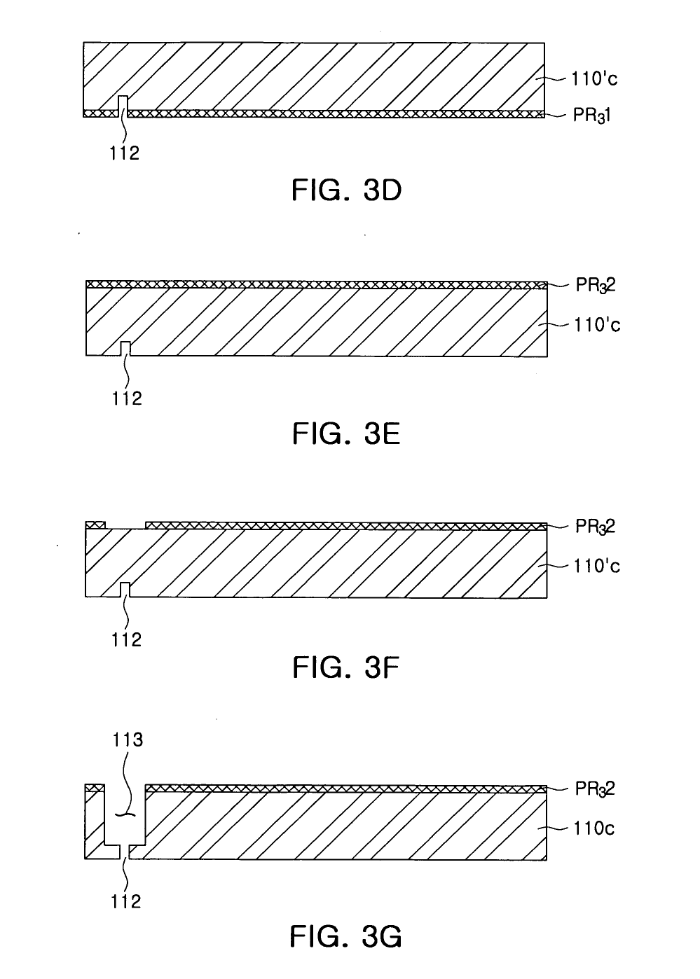

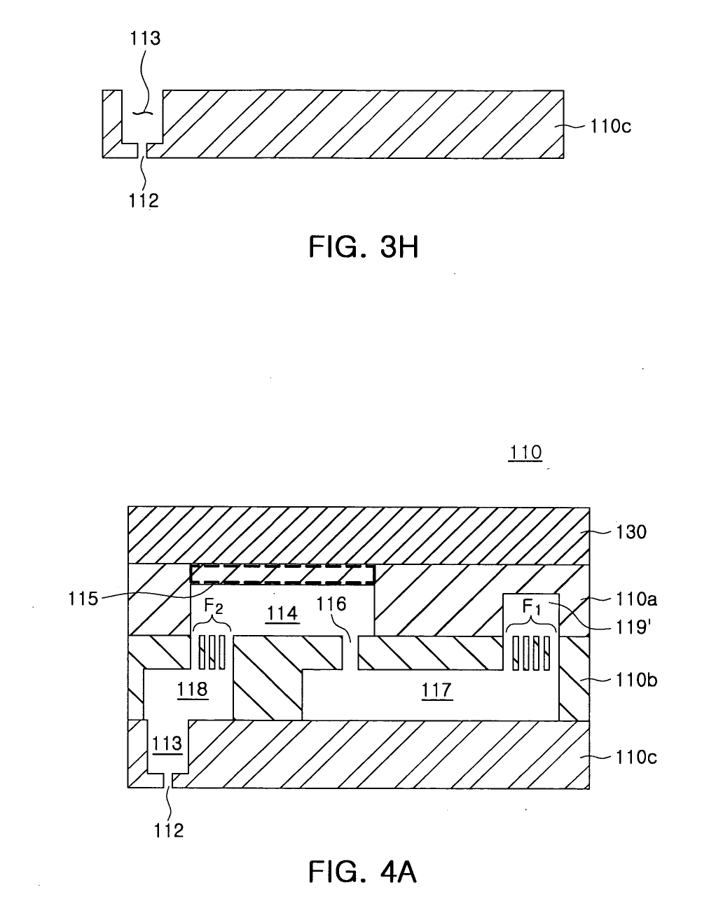

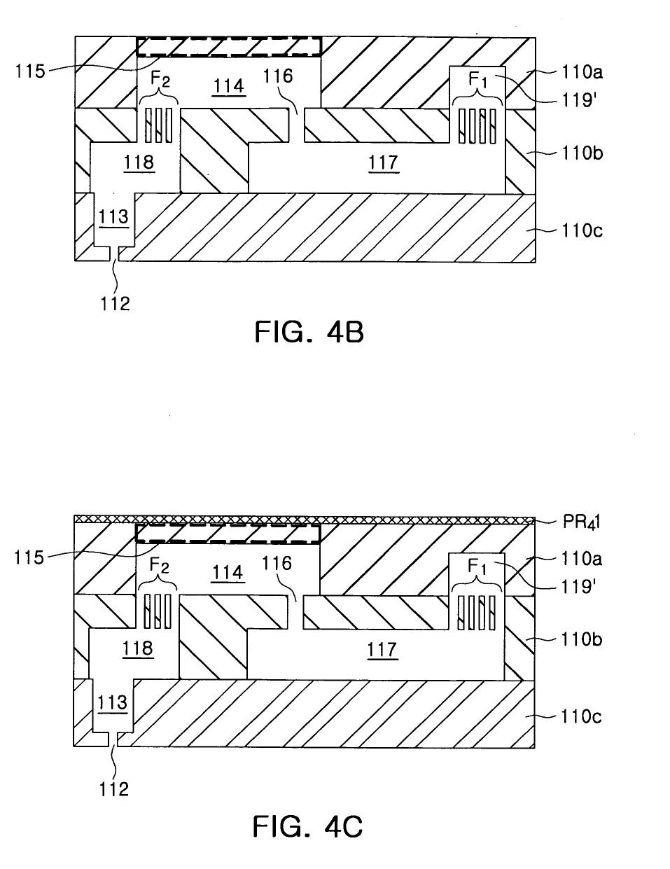

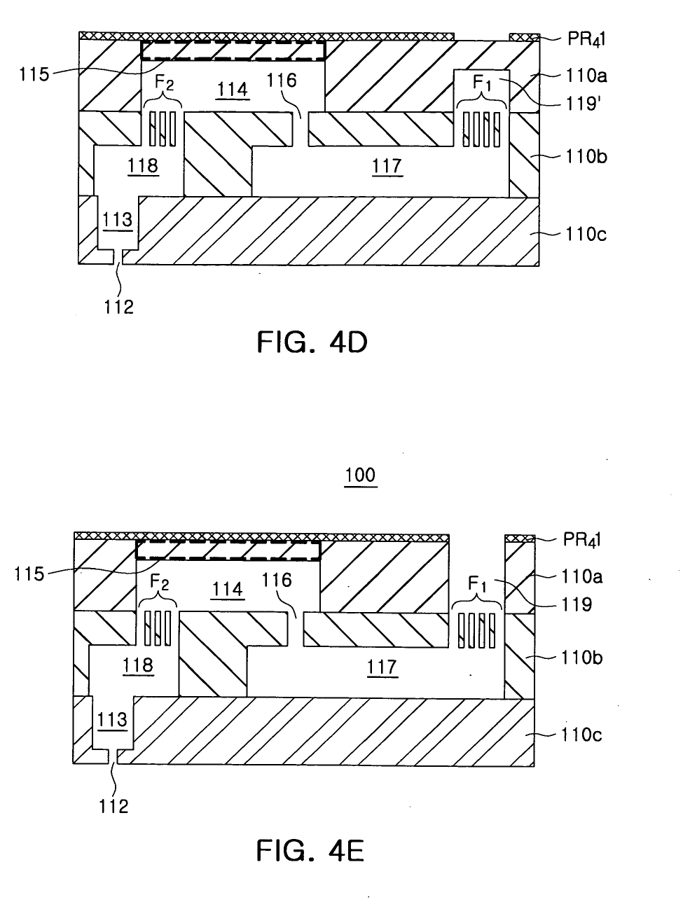

FIGS. 1A through 1F are schematic cross-sectional views illustrating a method of manufacturing a chamber plate of an inkjet print head according to an exemplary embodiment of the present invention. FIGS. 2A through 2G are schematic cross-sectional views illustrating a method of manufacturing an intermediate plate of an inkjet print head according to an exemplary embodiment of the present invention. FIGS. 3A through 3H are schematic cross-sectional views illustrating a method of manufacturing a nozzle plate of an inkjet print head according to an exemplary embodiment of the present invention. FIGS. 4A through 4E are schematic cross-sectional views illustrating a method of bonding a chamber plate, an intermediate plate and a nozzle plate of an inkjet print head according to an exemplary embodiment of the present invention.

A method of manufacturing an inkjet print head 100 according to an exemplary embodiment of the present invention includes providing a head portion 110 including a chamber plate 110a, an intermediate plate 110b and a nozzle plate 110c; bonding the chamber plate 110a, the intermediate plate 110b and the nozzle plate 110c; and removing a dummy portion 130. Here, the chamber plate 110a has an ink chamber 114 formed therein and the dummy portion 130 disposed on a surface of a pressure area 115 pressurizing the ink chamber 114. The nozzle plate 110c has a nozzle 112 formed therein. The intermediate plate 110b is interposed between the chamber plate 110a and the nozzle plate 110c and includes a damper 113 connecting the ink chamber 114 and the nozzle 112.

First of all, a method of manufacturing a chamber plate of an inkjet print head according to an exemplary embodiment of the invention will be described in detail with reference to FIGS. 1A through 1F.

As shown in FIG. 1A, an initial chamber plate 110′a formed of silicon is prepared.

Next, as shown in FIG. 1B, one surface of the initial chamber plate 110′a is bonded to the dummy portion 130. Here, the dummy portion 130 is bonded to a surface of the pressure area 115 pressurizing the ink chamber 114 to be formed thereafter (see FIG. 1E).

Then, as shown in FIG. 1C, a photoresist pattern PR₁1 is formed on the other surface of the initial chamber plate 110′a to which the dummy portion 130 is not bonded.

Then, as shown in FIGS. 1D and 1E, the photoresist pattern PR₁1 is etched so as to form the ink chamber 114 and a preliminary ink inlet 119′. Subsequently, part of the initial chamber plate 110′a is etched by using the photoresist pattern PR₁1 as a mask, thereby forming the ink chamber 114 and the preliminary ink inlet 119′.

Then, as shown in FIG. 1F, the photoresist pattern PR₁1, prepared for the forming of the ink chamber 114 and the preliminary ink inlet 119′, is removed.

In the above-described process, the method of etching the photoresist pattern PR₁1 and the initial chamber plate 110′a may be a reactive ion etching (RIE) method or a deep reactive ion etching (DRIE) method. However, the method of etching the photoresist pattern PR₁1 and the initial chamber plate 110′a is not limited thereto.

Also, if desired, an oxide film may be formed inside or outside the chamber plate 110a and the dummy portion 130.

Through the above process described with reference to FIGS. 1A through 1F, the chamber plate 110a of the inkjet print head 100, having the dummy portion 130 formed thereon, is prepared.

A method of manufacturing an intermediate plate of an inkjet print head according to an exemplary embodiment of the invention will be described in detail with reference to FIGS. 2A through 2G.

First of all, as shown in FIG. 2A, an initial intermediate plate 110′b formed of silicon is prepared.

Next, as shown in FIG. 2B, a photoresist pattern PR₂1 is formed on one surface of the initial intermediate plate 110′b.

Then, as shown in FIGS. 2C and 2D, the photoresist pattern PR₂1 is etched so as to form filters F1 and F2 and a restrictor 116. Subsequently, part of the initial intermediate plate 110′b is etched by using the photoresist pattern PR₂1 as a mask, thereby forming the filters F1 and F2 including a plurality of filter holes and the restrictor 116.

Thereafter, as shown in FIG. 2E, the photoresist pattern PR₂1, prepared for the forming of the filters F1 and F2 and the restrictor 116, is removed. Then, a photoresist pattern PR₂2 is formed on the other surface of the initial intermediate plate 110′b in which the filters F1 and F2 and the restrictor 116 are not formed.

Then, as shown in FIG. 2F, the photoresist pattern PR₂2 is etched so as to form a reservoir 117 and an ink flow path 118. Subsequently, part of the initial intermediate plate 110′b is etched, thereby forming the reservoir 117 and the ink flow path 118.

Then, as shown in FIG. 2G, the photoresist pattern PR₂2, prepared for the forming of the reservoir 117 and the ink flow path 118, is removed.

In the above-described process, the method of etching the photoresist patterns PR₂1 and PR₂2 and the initial intermediate plate 110′b maybe a RIE or a DRIE method. However, the method of etching the photoresist patterns PR₂1 and PR₂2 and the initial intermediate plate 110′b is not limited thereto.

Also, if desired, an oxide film may be formed inside or outside the intermediate plate 110b.

Through the above process described with reference to FIGS. 2A through 2G, the intermediate plate 110b of the inkjet print head 100 is prepared.

A method of manufacturing an nozzle plate of an inkjet print head according to an exemplary embodiment of the invention will be described in detail with reference to FIGS. 3A through 3H.

First of all, as shown in FIG. 3A, an initial nozzle plate 110′c formed of silicon is prepared.

Next, as shown in FIG. 3B, a photoresist pattern PR₃1 is formed on one surface of the initial nozzle plate 110′c.

Then, as shown in FIGS. 3C and 3D, the photoresist pattern PR₃1 is etched so as to form the nozzle 112.

Subsequently, part of the initial nozzle plate 110′c is etched by using the photoresist pattern PR₃1 as a mask, thereby forming the nozzle 112.

Then, as shown in FIG. 3E, the photoresist pattern PR₃1, prepared for the forming of the nozzle 112, is removed. Then, a photoresist pattern PR₃2 is formed on the other surface of the initial nozzle plate 110′c in which the nozzle 12 is not formed.

Then, as shown in FIGS. 3F and 3G, the photoresist pattern PR₃2 is etched so as to form the damper 113.

Subsequently, part of the initial nozzle plate 110′c is etched to thereby form the damper 113 connected to the nozzle 112.

Then, as shown in FIG. 3H, the photoresist pattern PR₃2, prepared for the forming of the damper 113, is removed.

In the above-described process, the method of etching the photoresist patterns PR₃1 and PR₃2 and the initial nozzle plate 110′c may be a RIE or a DRIE method. However, the method of etching the photoresist patterns PR₃1 and PR₃2 and the initial nozzle plate 110′c is not limited thereto.

Also, if desired, an oxide film may be formed inside or outside the nozzle plate 110c.

Through the above process described with reference to FIGS. 3A through 3H, the nozzle plate 110c of the inkjet print head 100 is prepared.

A method of bonding a chamber plate, an intermediate plate and a nozzle plate of an inkjet print head according to an exemplary embodiment of the invention will be described in detail with reference to FIGS. 4A through 4E.

First of all, with reference to FIG. 4A, the chamber plate 110a having the dummy portion 130, the intermediate plate 110b, and the nozzle plate 110c of the inkjet print head 100, individually prepared in the above-described process, are directly bonded to each other by performing a silicon direct bonding (SDB) between the lower surface of the chamber plate 110a and the upper surface of the intermediate plate 110b and between the lower surface of the intermediate plate 110b and the upper surface of the nozzle plate 110c. The SDB allows for the following connections: the filter F2 and the ink flow path 118 of the intermediate plate 110b are connected to the ink chamber 114 of the chamber plate 110a and the damper 113 of the nozzle plate 110c; the reservoir 117 and the restrictor 116 of the intermediate plate 110b are connected to the ink chamber 114 of the chamber plate 110a; and the reservoir 117 and the filter Fl of the intermediate plate 110b are connected to the preliminary ink inlet 119′ of the chamber plate 110a.

Next, with reference to FIG. 4B, the dummy portion 130 is polished and removed from the inkjet print head 100 having the chamber plate 110a, the intermediate plate 110b and the nozzle plate 110c directly bonded by the SDB. At this time, the dummy portion 130 is polished and removed by at least one of a chemical polishing (CP) method, a mechanical polishing (MP) method, a chemical mechanical polishing (CMP) method and a RIE method. Here, the dummy portion 130 is removed in such a manner that the chamber plate 110c may have a thickness of 10 μm to 50 μm .

Then, with reference to FIGS. 4C and 4D, a photoresist pattern PR₄1 is formed on the pressure area 115 of the chamber plate 110a, and is subsequently etched.

Then, as shown in FIG. 4E, part of the chamber plate 110a is etched by using the photoresist pattern PR₄1 as a mask, thereby forming an ink inlet 119. Accordingly, the manufacturing of the inkjet print head 100 according to this embodiment is completed.

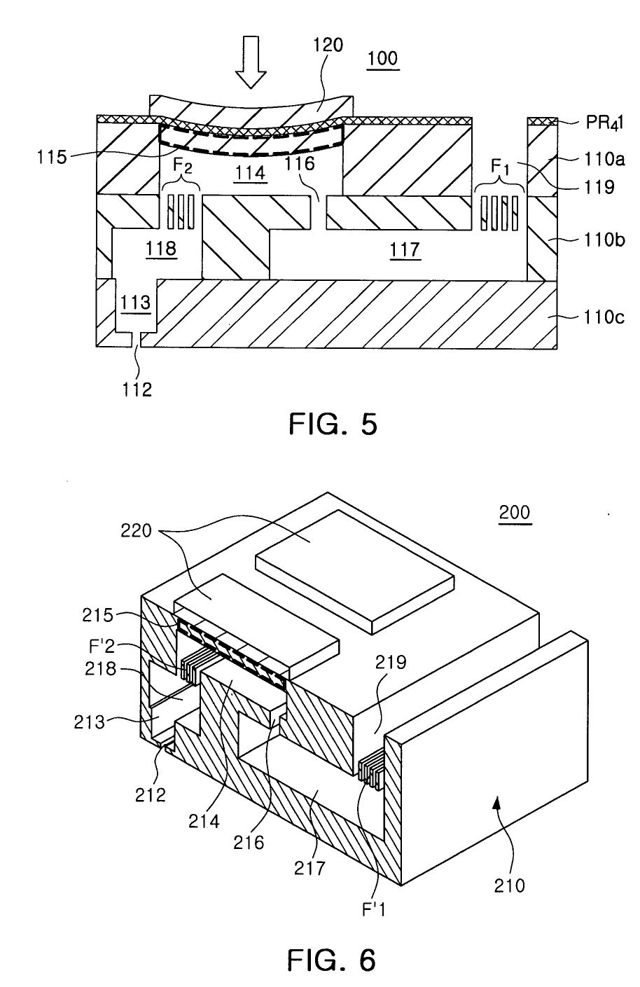

Hereinafter, an ink chamber of an inkjet print head according to an exemplary embodiment of the present invention will be described with reference to FIG. 5.

FIG. 5 is a schematic cross-sectional view illustrating an ink chamber of an inkjet print head according to an exemplary embodiment of the present invention.

With reference to FIG. 5, an actuator 120 is mounted on the ink chamber 114. The pressure area 115 is formed between the actuator 120 and a portion that forms the ceiling of the ink chamber 114. The pressure area 115 vibrates due to an electrical signal.

Here, the actuator 120 is bent toward the ink chamber 114. This bent shape causes the generation of pressure in the pressure area 115 and the internal volume of the ink chamber 114 is reduced so that the ink inside the ink chamber 114 is ejected to the outside through the ink flow path 118, the damper 113, and the nozzle 112.

The actuator 120, capable of converting electrical energy into mechanical energy or vice versa, may have electrodes electrically connected to the upper and lower surfaces thereof. The actuator 120 may be formed of Pb (Zr, Ti)O₃, which is a piezoelectric material.

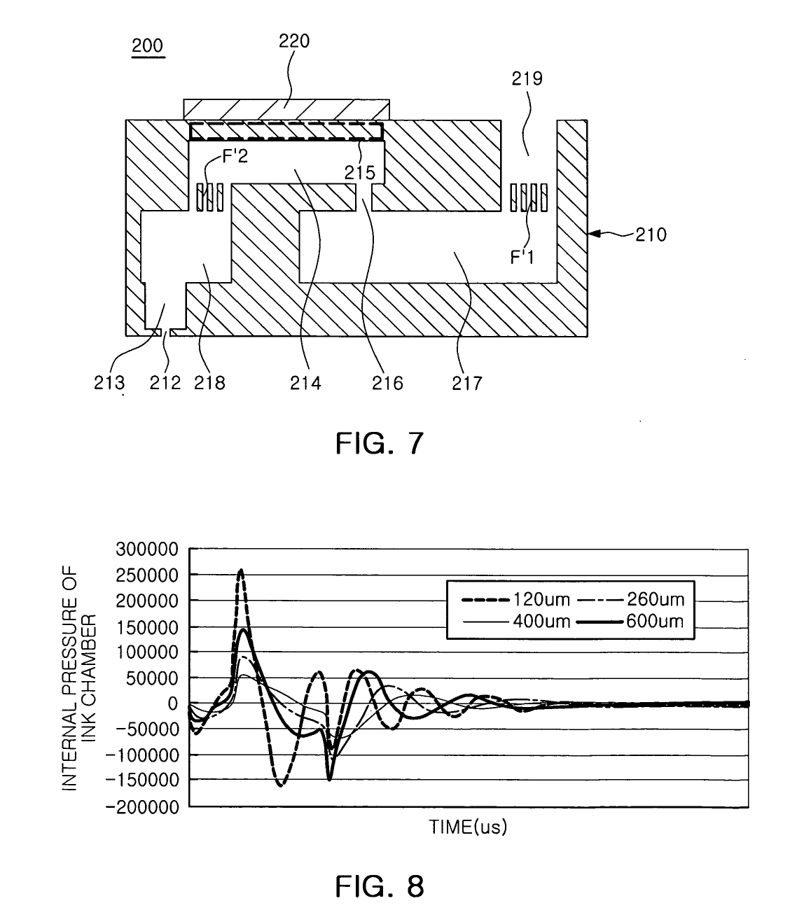

Hereinafter, an inkjet print head according to another exemplary embodiment of the present invention will be described with reference to FIGS. 6 and 7 with a focus on different features as compared with those of the aforementioned embodiment.

FIG. 6 is a partial perspective view schematically illustrating a method of manufacturing an inkjet print head according to another exemplary embodiment of the present invention. FIG. 7 is a cross-sectional view illustrating the inkjet print head of FIG. 6.

In the aforementioned embodiment, the head portion 110 is formed in such a manner that the chamber plate 110a having the dummy portion 130 formed thereon and the nozzle plate 110c having the nozzle 112 formed therein are bonded with the intermediate plate 110b interposed therebetween, and the dummy portion 130 is then removed from the head portion 110 being formed by the bonding process, whereby the inkjet print head 100 is formed.

In this embodiment, a head portion 210 of an inkjet print head 200 is formed of a single body. Inside the head portion 210, a nozzle 212, a damper 213, an ink chamber 214, a pressure area 215, a restrictor 216, a reservoir 217, an ink flow path 218, an ink inlet 219, and filters F′1 and F′2 are provided. An actuator 220 is mounted on the pressure area 215.

A dummy portion (not shown) is attached onto the upper surface of the pressure area 215 in the head portion 210 of the inkjet print head 200 according to this embodiment, until the mounting of the actuator 220. After the dummy portion is removed, the actuator 220 is mounted, whereby the inkjet print head 200 is formed.

Meanwhile, throughout all the exemplary embodiments of the invention, the dummy portion may be processed by not only being attached onto the upper surface of the pressure area of the head portion, but also calculating an extra portion for the dummy portion within the chamber plate itself, and the extra dummy portion may then be removed from the chamber plate.

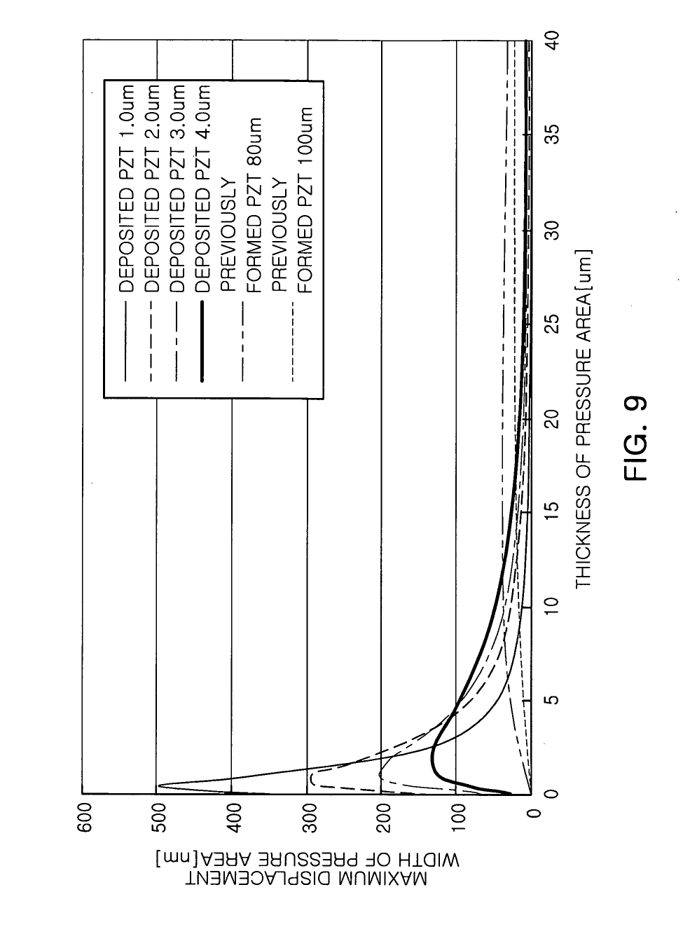

Hereinafter, the relationships between the thickness of a pressure area and the internal pressure variation of an ink chamber and between the thickness of an actuator and the maximum displacement width of a pressure area will be described with reference to FIGS. 8 and 9.

FIG. 8 is a graph illustrating the internal pressure variation of an ink chamber according to the thickness of a pressure area in an inkjet print head according to an exemplary embodiment of the present invention. FIG. 9 is a graph illustrating the thickness range of a pressure area having a maximum displacement width according to the thickness of an actuator in an inkjet print head according to an exemplary embodiment of the present invention.

With reference to FIG. 8, as the pressure area 115 within the chamber plate 110a becomes thinner to be 600 μm, 400 μm, 260 μm, and 120 μm, the magnitude of pressure applied to the ink chamber 114 becomes greater. Therefore, the greater reduction in the thickness of the pressure area 115 within an available range may allow for the improvement of ink ejection.

With reference to FIG. 9, it is understood that there is the thickness range of the pressure area 115 indicating the maximum displacement width thereof according to variations in the thickness of the actuator 120. For example, in the case that the actuator 120, formed by a sputtering method and having a thickness of 1.0 μm, is employed, the pressure area 115 has its maximum displacement width when it has a thickness of approximately 1.0 μm, and has displacement widths being some distance from the maximum displacement width when it has different thicknesses. On the other hand, in the case that the actuator 120, previously formed to have a thickness of 50 μm, is employed, the pressure area 115 has its maximum displacement width when it has a thickness of approximately 16 μm, and has displacement widths of a minor distance from the maximum displacement width even when it has different thicknesses.

As the thickness of the actuator 120 becomes greater, the maximum displacement width itself becomes smaller and the thickness of the pressure area 115 having the maximum displacement width also becomes greater. That is, in order to improve ink ejection, the thickness of the actuator 120 needs to be reduced and the thickness of the pressure area 115 also needs to be adjusted in line with the reduced thickness of the actuator 120 so as to have the maximum displacement width.

In order to freely adjust the thickness of the head portion as described above, a process allowing for the forming of a thin-type head portion using a dummy portion according to the exemplary embodiment of the present invention may be very useful.

As set forth above, a method of manufacturing an inkjet print head according to exemplary embodiments of the invention allows for the improvement of ink ejection and nozzle density.

A method of manufacturing an inkjet print head according to exemplary embodiments of the invention allows for the forming of a thin-type head portion using a dummy portion.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing an inkjet print head, the method comprising:
providing a head portion including a dummy portion disposed on a surface of an area pressurizing an ink chamber, a nozzle connected to the ink chamber for ink ejection, and the ink chamber for ink supply to the nozzle; and
removing the dummy portion.

2. The method of claim 1, wherein the providing of the head portion includes forming the dummy portion to be integrated with the head portion as a single body.

3. The method of claim 1, wherein the providing of the head portion includes forming the dummy portion to be attached to the head portion.

4. The method of claim 1, wherein the removing of the dummy portion is performed by using at least one method selected from the group consisting of a chemical polishing method, a mechanical polishing method, a chemical mechanical polishing method, and a reactive ion etching method.

5. The method of claim 1, wherein the providing of the head portion includes forming the ink chamber and the nozzle in a single body.

6. The method of claim 1, wherein the providing of the head portion includes forming a nozzle plate having the nozzle formed therein and forming a chamber plate having the ink chamber formed therein.

7. The method of claim 6, wherein the providing of the head portion includes forming an intermediate plate interposed between the chamber plate and the nozzle plate and having a damper formed therein, the damper connecting the ink chamber and the nozzle.

8. The method of claim 6, wherein the removing of the dummy portion is performed such that the chamber plate has a thickness of 10 μm to 50 μm.
